(19) United States
(12) Patent Application Publication
(10) Pub. No.: US 2018/0171708 A1
(43) Pub. Date: Jun. 21, 2018

(54) Support for the Shaft of a Winding Tube of an Awning

(71) Applicant: Llaza World, S.A., Alcover (ES)

(72) Inventor: David Alonso Fabregat, Alcover (ES)

(21) Appl. No.: 15/534,163

(22) PCT Filed: Dec. 1, 2015
(86) PCT No.: PCT/ES2015/070870

§ 371 Date: Jun. 8, 2017

(30) Foreign Application Priority Data
Dec. 9, 2014 (ES) P201431808

(51) Int. Cl. E06B 9/50; E06B 9/44; E04F 10/06; E06B 9/174

(52) U.S. Cl. CPC E06B 9/50; E06B 9/174; E04F 10/06; E06B 9/44

(57) ABSTRACT

The invention relates to a support for the shaft of a winding tube, comprising: a fixed part with a surface and a channeled portion for receiving said shaft; a movable part coupled to said surface, which can move between a first position wherein the channeled portion of the fixed part and a channeled portion of the movable part form a tubular cavity, and a second position defining an opening for accessing the channeled portion of the fixed part; characterised in that the movable part comprises a load end suitable for receiving said shaft as it is pushed against the movable part, moving said movable part into the second position, and positioning the shaft over said opening when the movable part is in said second position; and in that the support comprises elastic means associated with the movable part and the fixed part, which are designed to hold the movable part in said first position.

The present invention refers to a support for the shaft of a winding tube of an awning, roller blind, or other kind of similar canvas roof, which is capable of securing the winding tube to a bearing structure of the awning, allowing the shaft of said winding tube to rotate freely at the same time.

More specifically, with the support of the present invention the attachment and detachment of the winding tube is fast and easily allowed so that preventing the user or fitter to have to handle the support while the winding tube is being fitted. In addition, the support of the present invention also prevents the shaft of the winding tube from being accidentally dislodged from the support, once it has been installed in the same for example, due to a blow or to the force of the wind.

### BACKGROUND OF THE INVENTION

Awnings and roller blinds typically comprise a winding tube for rolling up the canvas, said tube being provided with a rotation shaft that protrudes from the sides. For the awning to operate correctly it is necessary to secure said sides to a bearing structure and couple the shaft of the winding tube to the mechanism for rolling the canvas up and down. In order to do so, the awning makes use of supports on each of the sides of the winding tube that, since they are fixed to a bearing structure, they secure the position of the shaft of the winding tube but also allow the shaft to rotate freely.

There are different known systems in the state of the art for fitting the winding tube of an awning in its supports. One of the most common systems consists of using a bushing with a retractable or extensible tip coupled to one of the sides of the winding tube, with said tip being on the same axis as the shaft of said tube. Therefore, in order to introduce the extensible tip of the bushing in the tubular cavity of the support that is ready to receive the bushing, pressure must be exerted on the tip of the bushing, using the fingers for example, in order to retract it and thus fit the winding tube between the two lateral supports thereof. The extensible tip regains its extended position once pressure remits, entering the tubular cavity of the support so that the winding tube is secured to the support.

Alternatively, the bushing with an extensible tip can be jointly coupled to one of the supports instead of a side of the winding tube. In this case, in order to insert the winding tube between said supports, first pressure must be exerted on the extensible tip of the bushing in order to fit the shaft of the winding tube between the supports, and then release the extensible tip so that it regains its extended position and secures the shaft of said tube inside it.

However, this system has the drawback that it is necessary to handle the bushing with an extensible tip while holding and pushing the winding tube, which complicates, slows down and makes cumbersome the process of fitting the awning by the user or fitter, sometimes even requiring two or more people in order to fit very large tubes.

Some known attempts to facilitate the process of fitting the winding tube of an awning consist of splitting the process in different and separate events, firstly handling the supports of the shaft of said tube, and secondly inserting the winding tube.

Therefore, DE19612245, EP32884 and NL8400103, for example, offer solutions wherein the support for the shaft of the winding tube is formed by a fixed part designed to be attached to a bearing structure, and a movable part coupled to the fixed part. In order to insert the winding tube according to these solutions, firstly the movable part needs to be removed, and then the shaft of the winding tube has to be inserted in the fixed part until it rests on the tubular cavity of the fixed part designed for said purpose. Finally, it is necessary to couple the movable part to the fixed part again so the shaft of said tube is secured between them.

Publications FR2982310, EP1310628 and EP0465433 disclose an improved version of this type of solution, wherein the tubular cavity of the support is located in the movable part. In this way, fitting the winding tube requires firstly to fit the movable part on the end of the shaft of the winding tube, for example sliding the movable part along the axis of said shaft, and then coupling the movable part with the shaft of said tube that is already secured inside the fixed part.

Another known solution comprises a support with a fixed part and a movable part connected to the fixed part, which can pivot or move in relation to the fixed part. In this way, the movable part can be in a first position (or closed configuration of the support), wherein the fixed part and the movable part comprise between them a tubular cavity capable of holding inside it the shaft of the winding tube, allowing said shaft to rotate freely, and a second position (or open configuration of the support), wherein the movable part has moved in relation to the fixed part, allowing the shaft of the winding tube to enter inside the support. Publications DE202010000163 and FR2952117 show some examples wherein the movable part pivots in relation to the fixed part, while EP0518268 and GB418618 disclose examples wherein the movable part moves in relation to the fixed part along a vertical plane perpendicular to the plane in which the winding tube is inserted in the support.

Although they may be less uncomfortable than the solutions that use the bushing with the extensible tip, these solutions still have the drawback that the operation of fitting the winding tube in the support is slow and requires the user or fitter to handle to a large degree the parts that comprise the support.

Therefore, it would be beneficial to have a support for the shaft of the winding tube of an awning that allows the tube to be attached (and detached) quickly and simply, and that does not require the user or fitter to handle it, especially while the winding tube is being inserted in said support. It would also be beneficial for said support to be able to hold the shaft of the winding tube in place, preventing it from being dislodged accidentally.

### DESCRIPTION OF THE INVENTION

The support for the shaft of a winding tube of an awning, roller blind, or other similar kinds of canvas roofs, which is the invention, manages to solve the aforementioned drawbacks and displays other advantages described below.

One aspect of the present invention refers to a support for a shaft of a winding tube of an awning, comprising:
a fixed part designed to be secured to a bearing structure, wherein the fixed part comprises a surface stretching from a front end and a rear end of said fixed part, and a channeled portion suitable for receiving the shaft of a winding tube, with the channeled portion being located in an intermediate area of said surface; and
a movable part coupled to said surface, which can move in relation to the fixed part in a direction between a first position (closed configuration of the support), wherein the channeled portion of the fixed part and a channeled portion of the movable part form a tubular cavity capable suitable for securing the shaft of the winding tube inside it, allowing said tube to move freely, and a second position (open configuration of the support) wherein the movable part is displaced in relation to the fixed part towards said rear end part, defining between both parts an opening adapted for the shaft of the winding tube to be able to access a channeled portion of the fixed part.

Said support is characterised in that the movable part comprises a load end adapted for receiving the shaft of the winding tube while said shaft is pushed against the movable part towards said rear end in a direction parallel to the direction of movement of the movable part, moving said movable part into the second position, and for positioning said shaft over the opening defined between the movable part and the fixed part when the movable part is in said second position; and in that the support comprises elastic means associated with the movable part and with the fixed part, the elastic means being configured to push the movable part towards said front end, holding the movable part in said first position when the shaft of the winding tube is housed in the channeled portion of the fixed part.

According to the present invention, when a winding tube is pushed for its installation, the load end of the movable part is adapted for receiving the shaft of said tube, causing the movable part to move towards the rear end of the fixed part until it reaches the second position. In this way, the support switches to the open configuration without having to be handled by the user or installer.

In said open configuration, the load end positions the shaft of the winding tube over the opening defined between the movable part and the fixed part, guiding it towards the channeled portion of the fixed part, facilitating the insertion of inserting said shaft.

In addition, once the force of pushing of the shaft of the winding tube against the load end stops, the elastic means ensure that the return of movable part to the front end of the fixed part. The force exerted by said elastic means keeps the support in the closed configuration, so the shaft of the winding tube is held in the tubular cavity of the support. Therefore, the elastic means prevent the movable part from abandoning said first position unless the user or installer exerts a pushing force, preventing said shaft from being accidentally dislodged from the support.

In one of the embodiments of the present invention, the surface of the fixed part comprises a first flat portion located between said front end and the channeled portion of the fixed part, with the first flat portion being substantially parallel to the plane defined by the direction the movable part moves and the direction of the channel of the channeled portion of the fixed part.

In this way, during the installation manoeuvre of the winding tube, while the shaft of said tube is pushed against the load end of the movable part, the shaft can be conveniently placed, or at least rested on, over said first flat portion, preventing the user or the installer from having to hold the whole weight of the winding tube by themselves.

Preferably, in this embodiment the load end comprises a second flat portion located substantially perpendicular to the first flat portion, and a retention protrusion adjacent to the edge of the second flat portion that is further away from said surface.

During the installation of the winding tube, said second flat portion offers a larger contact surface area for the shaft of the winding tube, so that said shaft can push the load end of the movable part more efficiently. In addition, the retention protrusion ensures that the shaft of the winding tube remains in contact with said first flat portion while said shaft is pushed towards the rear end of the fixed part, preventing the shaft of the winding tube from being dislodged if the user or installer pushes said tube at an angle to the plane defined by the direction the movable part moves and to the direction of the channel of the channeled portion of the fixed part.

More preferably, in this embodiment the second flat portion is substantially aligned with the edge of the channeled portion of the fixed part closest to the rear end of said surface when the movable part is in said second position.

In this way, said second flat portion conveniently guides the shaft of the winding tube while this access the channeled portion of the fixed part simply by the force of its own weight.

Optionally, in this embodiment the fixed part comprises a stopping element adapted for limiting the path of the movable part towards said front end part. The stopping element conveniently prevents the movable part from moving excessively towards the front end of the fixed part by using the elastic means, preventing the movable part from decoupling from the fixed part.

Preferably, said stopping element is located on the surface of the fixed part between said front end and the channeled portion of the fixed part. This configuration makes easier the assembly of the movable part and the fixed part.

In the context of the present invention, a surface is substantially parallel to another if the angle between their respective planes is no greater than 10 degrees. Similarly, a surface is substantially perpendicular to another if the angle between their respective planes is between 80 and 100 degrees.

In some embodiments, the load end comprises a cavity adapted for receiving the tip of a pushing element, such as a screwdriver, a punch or another pointed tool. In this way it is possible to move manually the movable part according to said moving direction towards the second position, for example, to disassemble the shaft of a winding tube housed in the tubular cavity of said support.

In some embodiments, the surface of the fixed part comprises a guide-rail located between the channeled portion of the fixed part and said rear end part. In addition, in these embodiments the movable part comprises a cart configured to couple to the guide-rail and move along it on said direction.

The configuration of the guide-rail/cart is able to restrict the movement of the movable part in relation to the fixed part to a linear movement in said direction. Therefore, it makes it even more difficult for a blow or the force of the wind to be able to cause the movable part to move in an undesired way, accidentally dislodging the shaft of a winding tube housed in the tubular cavity of the support.

Preferably in these embodiments: the cart comprises a cavity inside it provided with a longitudinal opening on a side of said cart adapted for sliding over the guide-rail of the fixed part; said guide-rail comprises a protrusion which, when the cart is coupled to the guide-rail, is inserted in said cavity through its longitudinal opening; and the elastic means are housed in said cavity, a first end of the elastic means being joined to the protrusion of the guide-rail and a second end of said elastic means being joined to a securing element located in an inner side of said cavity.

As they are placed inside the movable part, the movable part itself advantageously protects the elastic means, preventing them from jamming with other elements of the awning on which the support is mounted.

In some embodiments, the elastic means comprise a compression spring. However, in other embodiments the elastic means comprise a strip.

Similarly, in some embodiments, the elastic means are made of metal, while in other embodiments the elastic means are made of plastic or a synthetic material.

Preferably, the elastic means and a part selected between the fixed part and the movable part are integrally formed making-up a single piece. In this way, the number of components of the support is reduced, while at the same time the assembly of the movable part and the fixed part is simplified.

In some embodiments, the support is symmetrical in relation to a plane perpendicular to the direction of the channel of the channeled portion of the fixed part. In this way, a same support can be advantageously used alternatively in either of the two sides of the winding tube of an awning, avoiding the need for the assembly kit to contain specific supports for the right and left sides.

The present invention also refers to a roller blind that comprises: a winding tube for a piece of canvas equipped on each side with respective supports for the shaft of said tube; and a load bar coupled to an edge of the canvas; wherein at least one of said supports is a support for the shaft of a winding tube according to the present invention.

Optionally, said roller blind also comprises two guides located on each side of the winding tube that extend longitudinally along the direction of movement of the canvas.

Similarly, the present invention also refers to an awning that comprises: a winding tube for a piece of canvas equipped on each side with respective supports for the shaft of said tube; a load bar securing the front of the canvas; and two articulated arms linked to the load bar in order to fold or unfold the canvas; where at least one of said supports is a support for the shaft of a winding tube according to the present invention.

### BRIEF DESCRIPTION OF THE FIGURES

To complete the description provided above, a series of drawings are included for illustration purposes and without limitation, wherein an embodiment has been represented:

FIG. 1 shows a support for the shaft of a winding tube according to an embodiment of the present invention.

FIG. 2 shows a plane lateral view of the support of FIG. 1, with the support in an initial resting configuration, which indicates the position that would be occupied by the shaft of a winding tube placed against the load end of the movable part of the support.

FIG. 3 corresponds to a plane lateral view of the support of FIG. 1, when the support is in the open configuration, representing how the shaft of the winding tube would be positioned over the opening defined between the movable part and the fixed part.

FIG. 4 presents a plane lateral view of the support of FIG. 1, when the support is in the closed configuration, displaying the shaft of the winding tube secured in the tubular cavity comprised by the channeled portions of the fixed part and the movable part.

FIG. 5 corresponds to a section of the support shown on FIG. 3 (open configuration) according to a plane perpendicular to the direction of the channel of the channeled portion of the fixed part of the support, which divides the support in two halves that are substantially the same.

FIG. 6 shows a crosswise section of the support shown on FIG. 4 (closed configuration) in the same plane as FIG. 5.

FIG. 7 presents an exploded plane lateral view of the support for the shaft of a winding tube of FIG. 1.

FIGS. 8, 9 and 10 show three different moments in the fitting process of the shaft of a winding tube of a roller blind comprising a support according to an embodiment of the present invention.

### DESCRIPTION OF A PREFERRED EMBODIMENT

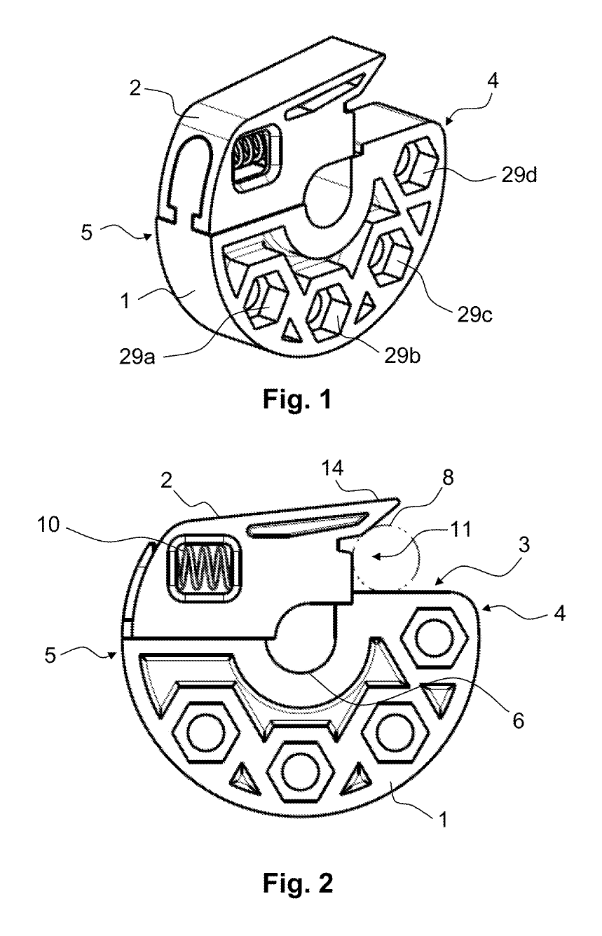

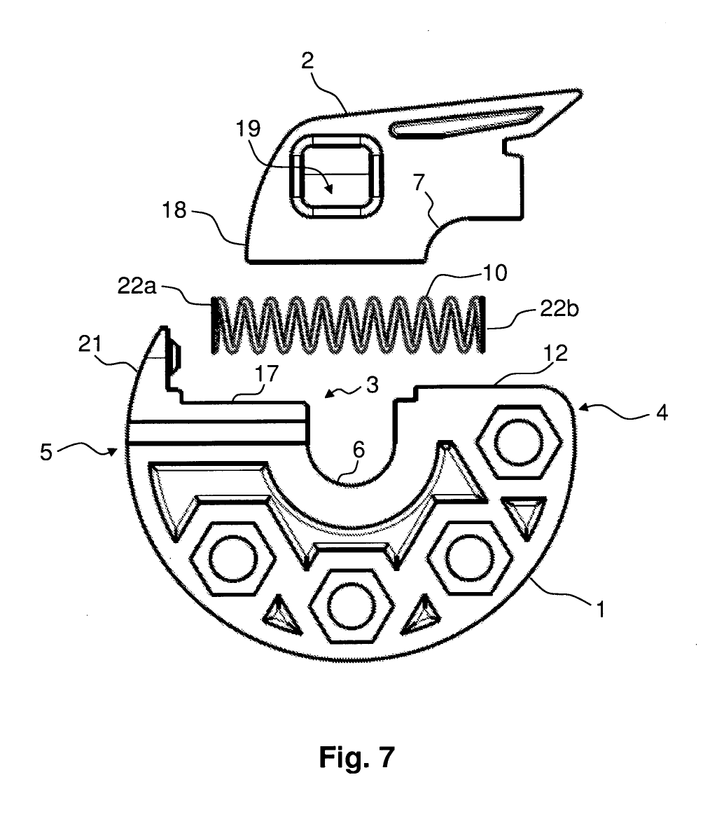

FIGS. 1-7 show an embodiment of the support for the shaft of a winding tube of the present invention. More specifically, the support comprises a fixed part 1 designed to be secured to a bearing structure. In order to do so, the fixed part 1 comprises four housings 29a-d configured to receive their respective nuts where fixing screws are screwed. The fixed part 1 comprises a surface 3 stretching from a front end 4 and a rear end 5 of said fixed part, and a channeled portion 6 suitable for receiving the shaft 8 of a winding tube, the channeled portion 6 being located in an intermediate area of said surface 3. The support also comprises a movable part 2 coupled on said surface 3, and elastic means 10 associated with the movable part 2 and with the fixed part 1.

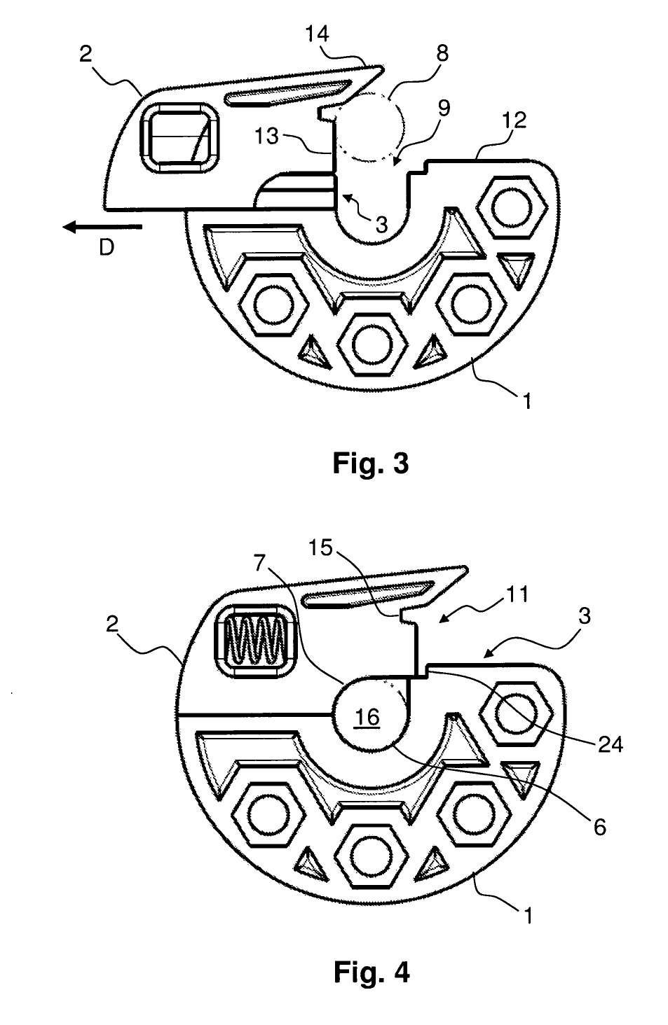

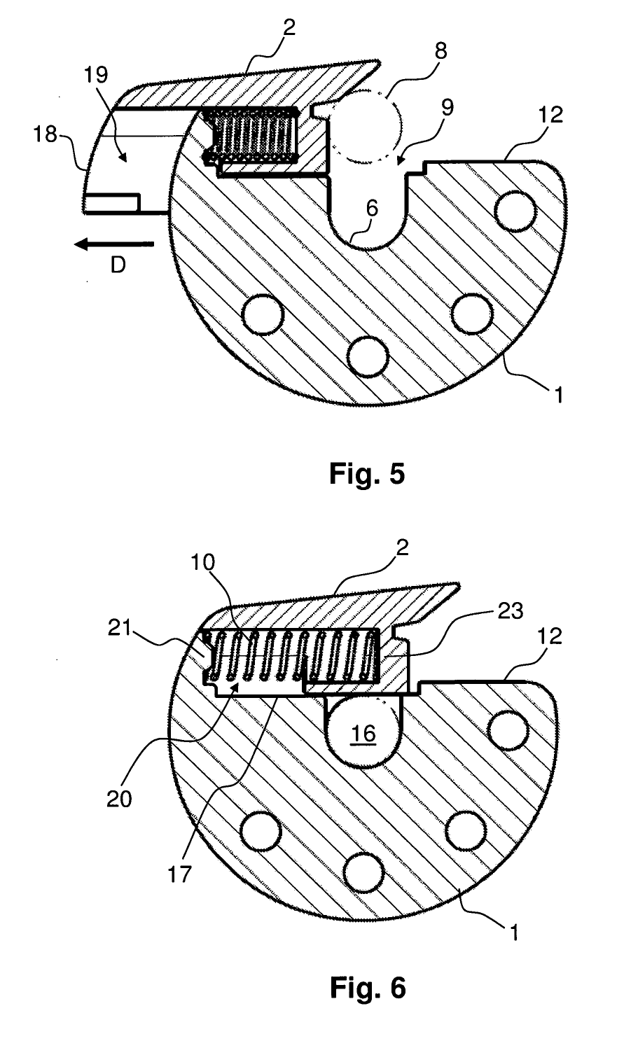

The movable part 2 can move in relation to the fixed part 1 in a displacement direction D between a first position (as shown on FIGS. 4 and 6), wherein the channeled portion 6 of the fixed part and a channeled portion 7 of the movable part make up between them a tubular cavity 16 suitable for securing inside it the shaft 8 of the winding tube, allowing said tube to rotate freely, and a second position (shown on FIGS. 3 and 5) wherein the movable part 2 is displaced with respect to the fixed part 1 towards said rear end 5, defining between both parts an opening 9 adapted for the shaft 8 of the winding tube to access to the channeled portion 6 of the fixed part.

The movable part 2 comprises a load end 11 adapted for receiving the shaft 8 of the winding tube while said shaft is pushed against the movable part 2 towards said rear end 5 along a direction parallel to the displacement direction D of the movable part, moving said movable part 2 into the second position, and for positioning said shaft 8 over the opening 9 defined between the movable part 2 and the fixed part 1 when the movable part 2 is in said second position.

The surface 3 of the fixed part comprises a first flat portion 12 located between said front end 4 and the channeled portion 6 of the fixed part, with the first flat portion 12 being substantially parallel to the plane defined by the displacement direction D of the movable part and the direction of the channel of the channeled portion 6 of the fixed part.

The load end 11 comprises a second flat portion 13 located substantially perpendicular to the first flat portion 12, and a retention protrusion 14 adjacent to the edge of the second flat portion 13 that is further away from said surface 3. In addition, the load end 11 also comprises a cavity 15 adapted for receiving the tip of a pushing element, more specifically a flat head screwdriver.

The elastic means 10 comprises a compression spring and they are configured to push the movable part 2 towards said front end 4, keeping the movable part 2 in said first position when the shaft 8 of the winding tube is housed in the channeled portion 6 of the fixed part.

The fixed part 1 comprises a stopping element 24 adapted for limiting the path of the movable part 2 towards said front end 4. Said stopping element 24 is located on the surface 3 of the fixed part between said front end 4 and the channeled portion 6 of the fixed part.

FIGS. 2-4 show the sequence of insertion of the shaft of a winding tube in the support. More specifically, FIG. 2 represents the support in an initial resting configuration, wherein the movable part 2 is pushed by the elastic means 10 until reaching the end of its path, where the load end 11 is in contact with the stopping element 24.

In FIG. 2 it can be observed the shaft 8 of a winding tube located over the first flat portion 12 and in contact with the second flat portion 13 of the load end 11. Said shaft 8 is fitted between the retention protrusion 14 and said first flat portion 12.

When pushing the shaft 8 of the winding tube against the movable part 2 towards the rear end part 5 of the fixed part in a direction parallel to direction D, the movable part 2 moves until it finally reaches said second position. FIG. 3 shows the support in its open configuration, displaying that the second flat portion 13 is substantially aligned with the edge of the channeled portion 6 of the fixed part closest to the rear end 5 of said surface 3.

When the support is in the open configuration, the second flat portion 13 guides the shaft 8 of the winding tube as the latter falls towards the channeled portion 6 of the fixed part.

As the pushing force against the load end 11 of the movable part ceases, the elastic means 10 push said movable part 2 towards the front end 4 of the fixed part until it reaches said first position, retaining the shaft 8 in the tubular cavity 16. FIG. 4 represents the support in the closed configuration with the shaft 8 of the winding tube housed inside it.

As can be seen in FIGS. 2 and 4, in this embodiment the final path position of the movable part 2 is different from said first position wherein the support is in the closed configuration. However, in other embodiments both positions could be the same.

FIGS. 5 and 6 respectively show a section of the support in the open and closed configuration thereof. In them it can be observed that the surface 3 of the fixed part comprises a guide-rail 17 located between the channeled portion 6 of the fixed part and said rear end 5, and that the movable part 2 comprises a cart 18 configured to be coupled to the guide-rail 17 and to slide on it in the displacement direction D.

More specifically, the cart 18 comprises inside it a cavity 19 provided with a longitudinal opening 20 in one side of said cart, adapted for sliding on the guide-rail 17 of the fixed part 1. At the same time, the guide-rail 17 comprises a protrusion 21 that is inserted in said cavity 19 by means of the longitudinal opening 20 thereof when the cart is coupled to the guide-rail. In addition, the elastic means 10 are housed in said cavity 19, a first end part 22a of the elastic means being joined to the protrusion 21 of the guide-rail and a second end part 22b of said means being joined to a securing element 23 located in an inner side of said cavity 19.

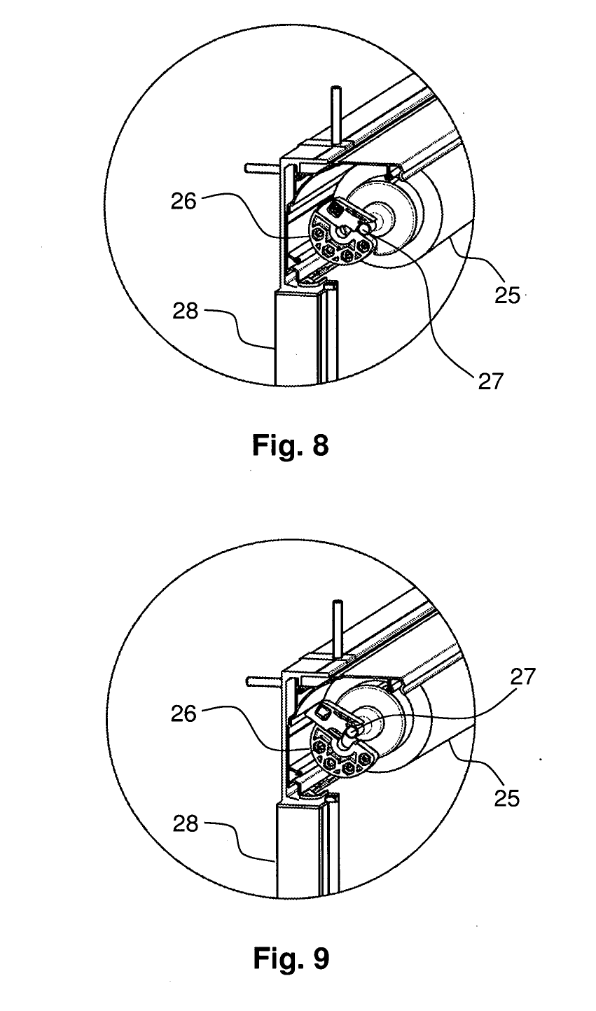

Finally, FIGS. 8-10 provide a partial view of a roller blind centred on one of the two sides of the winding tube, and correspond to three different moments in the process of installing the shaft of said tube.

More specifically, the roller blind comprises: a winding tube 25 for a piece of canvas and a load bar coupled to an edge of the canvas. The winding tube 25 is provided with respective supports 26 for the shaft 27 of said tube on each of the sides thereof, said supports 26 being according to the embodiment described in relation to FIGS. 1-7.

In this specific example, the roller blind also comprises two guides 28 located at each side of the winding tube 25 that stretch longitudinally in the direction the canvas moves. However, in other examples the roller blind does not include these lateral guides.

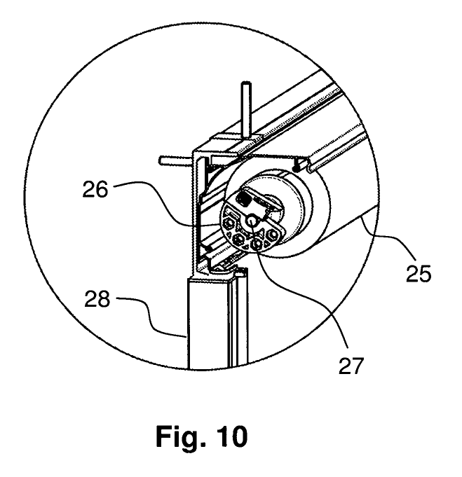

In first place, as shown in FIG. 8, in order to fit the winding tube 25 of the roller blind it is necessary to face the shaft 27 of said tube with the load end of the movable part of the support 26, which is in the initial resting configuration. Next, when pushing the winding tube 25 against said load end, the movable part of the support moves progressively towards the rear end of the fixed part of the support 26 along said displacement direction D until it reaches said second position. In this sense, FIG. 9 represents the support 26 in the open configuration, with the shaft 27 positioned to be inserted in the channeled portion of the fixed part of the support 26. Finally, once the shaft 27 is housed in said channeled portion, and when the pushing force on the winding tube 25 has ceased, the elastic means of the support 26 push the movable part towards the front end of the fixed part until it is positioned in said first position. Therefore, FIG. 10 shows the support 26 in the closed configuration with the shaft 27 of the winding tube already installed.

Although a specific embodiment of the invention has been referenced, it is evident for a person skilled in the art that the support for the shaft of a winding tube of an awning described could have numerous variations and modifications, and that all the details mentioned can be replaced by others that are technically equivalent, without falling outside the scope of protection defined by the following claims.

1. A support for a shaft of a winding tube, comprising:
a fixed part adapted for being fixed to a bearing structure, wherein the fixed part comprises a surface stretching from a front end and a rear end of said fixed part, and a channeled portion for receiving the shaft of a winding tube, the channeled portion being located in an intermediate area of said surface;
a movable part coupled on said surface, with said movable part being able to move in relation to the fixed part a displacement direction between a first position, where the channeled portion of the fixed part and a channeled portion of the movable part make up between them a tubular cavity for securing inside it the shaft of the winding tube, allowing said shaft to rotate freely, and a second position, wherein the movable part is displaced with respect to the fixed part towards said rear end part, defining between both parts an opening adapted for the shaft of the winding tube to be able to access the channeled portion of the fixed part;
wherein the movable part comprises a load end adapted for receiving the shaft of the winding tube while said shaft is pushed against the movable part towards the rear end in a parallel direction to the displacement direction of the movable part, moving said movable part to the second position, and for positioning said shaft over the opening defined between the movable part and the fixed part when the movable part is in said second position; and wherein the support also comprises elastic means associated with the movable part and with the fixed part, the elastic means being configured to push the movable part towards said front end, holding the movable part in said first position when the shaft of the winding tube is housed in the channeled portion of the fixed part.

2. The support according to claim 1, wherein the surface of the fixed part comprises a first flat portion located between said front end and the channeled portion of the fixed part, with the first flat portion being substantially parallel to the plane defined by the displacement direction of the movable part and the direction of the channel of the channeled portion of the fixed part.

3. The support according to claim 2, wherein the load end comprises a second flat portion located substantially perpendicular to the first flat portion and a retention protrusion adjacent to the edge of the second flat portion that is further away from said surface.

4. The support according to claim 3, wherein the second flat portion is substantially aligned with the edge of the channeled portion of the fixed part closest to the rear end of said surface when the movable part is in said second position.

5. The support according to claim 2, wherein the fixed part comprises a stopping element adapted for limiting the path of the movable part towards said front end part.

6. The support as claimed in claim 1, wherein the load end comprises a cavity adapted for receiving the tip of a pushing element.

7. The support according to claim 1, wherein the surface of the fixed part comprises a guide-rail located between the channeled portion of the fixed part and said rear end, and wherein the movable part comprises a cart configured to be coupled to the guide-rail and to slide on it in the displacement direction.

8. The support according to claim 7, wherein the cart comprises inside it a cavity with a longitudinal opening on a side of said cart adapted for sliding on the guide-rail of the fixed part; wherein said guide-rail comprises a protrusion which, when the cart is coupled to the guide-rail, is inserted in said cavity through the longitudinal opening; and wherein the elastic means are housed in said cavity, with a first end of the elastic means joined to the protrusion of the guide-rail and a second end of said elastic means joined to a securing element located on an inner side of said cavity.

9. The support according to claim 1, wherein the elastic means comprise a compression spring.

10. The support according to claim 1, wherein the elastic means comprise a strip.

11. The support according to claim 1, wherein the elastic means are made of metal.

12. The support according to claim 1, wherein the elastic means are made of plastic or a synthetic material.

13. The support according to claim 1, wherein the elastic means and a part selected between the fixed part and the movable part are formed of a single piece.

14. A roller blind comprising: a winding tube for a piece of canvas equipped on each side with respective supports for the shaft of said tube; and a load bar secured to an edge of the canvas; wherein at least one of said supports is a support according to claim 1.

15. An awning comprising: a winding tube for a piece of canvas equipped on each side with respective supports for the shaft of said tube; a load bar securing the front of the canvas; and two articulated arms linked to the load bar in order to unfold or fold the canvas; wherein at least one of said supports is a support according to claim 1.

16. The support according to claim 5, wherein said stopping element is located on the surface of the fixed part between said front end part and the channeled portion of the fixed part.
